(19) United States
(12) Patent Application Publication
(10) Pub. No.: US 2015/0116352 A1
(43) Pub. Date: Apr. 30, 2015

(54) GROUPS CONTROL METHOD, SYSTEM FOR A DYNAMIC MAP-TYPE GRAPHIC INTERFACE AND ELECTRONIC DEVICE USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: TZU-HSIANG LAN, New Taipei (TW); WEI SONG, Shenzhen (CN)

(21) Appl. No.: 14/519,336

(22) Filed: Oct. 21, 2014

(30) Foreign Application Priority Data
Oct. 24, 2013 (CN) 201310505623.X

(51) Int. Cl. G09G 5/37; G06F 3/0481

(52) U.S. Cl. CPC G09G 5/37; G06F 3/04817; G09G 2340/0464; G09G 2340/14
USPC 345/629

(57) ABSTRACT

A dynamic map-type graphic interface includes a number of user interface (UI) components. Each UI component is associated with one corresponding application program of the electronic device. The dynamic map-type graphic interface is a single-layer graphic interface made up of the first groups spliced together and centered around a center of the dynamic map-type graphic interface. Each of the first group comprising at least one user interface (UI) component spliced together.

### FIELD

The present disclosure relates to graphic user interface technologies, and particularly to a dynamic map-type graphic interface, an electronic device providing the dynamic map-type graphic interface, and a method for the electronic device to provide the dynamic map-type graphic interface.

### BACKGROUND

User interfaces (UIs) are physical or virtual mediums through which a user interacts with an electronic device. Most electronic devices use graphic user interface (GUI) components supported in an operating system (OS). The GUIs of electronic devices may have many application icons, making it necessary to arrange the application icons in different layers or pages of the GUI.

### BRIEF DESCRIPTION OF THE DRAWINGS

Implementations of the present technology will now be described, by way of example only, with reference to the attached figures.

FIG. 1 is an isometric view of an embodiment of an electronic device.

FIG. 2 is a block diagram of the electronic device of FIG. 1.

FIG. 3 is a diagrammatic view of a first embodiment of a dynamic map-type graphic interface.

FIG. 4 is a diagrammatic view of another embodiment of a dynamic map-type graphic interface.

FIG. 5 is a flowchart of an embodiment of a method for providing the dynamic map-type graphic interface.

FIG. 6 is a diagrammatic view of a second embodiment of a dynamic map-type graphic interface.

FIG. 7 is a flowchart of an embodiment of a groups control method for controlling the dynamic map-type graphic interface.

FIG. 8 a diagrammatic view of an embodiment of a moving process of the dynamic map-type graphic user interface.

FIG. 9 is a flowchart of an embodiment of a control method for controlling a user interface of the electronic device employing the dynamic map-type graphic interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

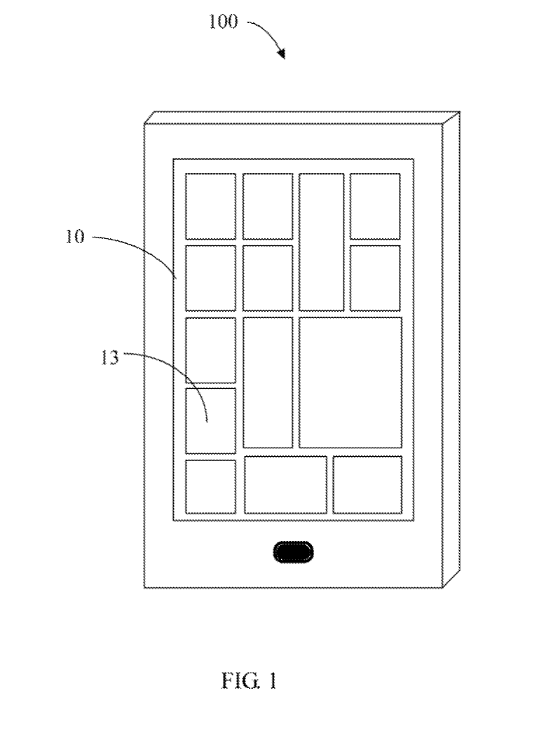

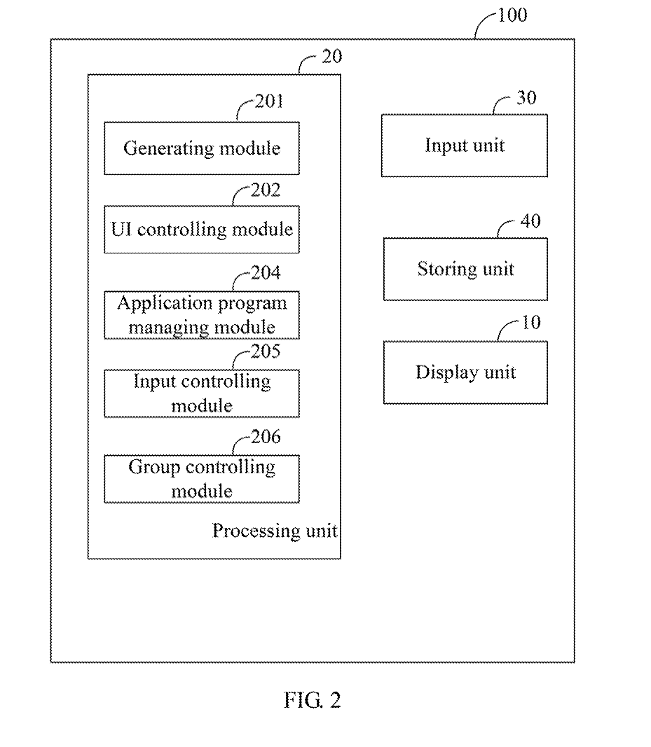

FIGS. 1 and 2 illustrate an electronic device 100 of one embodiment. The electronic device 100 includes a display unit 10, a processing unit 20, an input unit 30, and a storage unit 40. The display unit 10 of the electronic device 100 can be any size, and the electronic device 100 can be, without limitation, a television, an electronic whiteboard, a desktop personal computer, a notebook, a tablet personal computer, a smart phone, or a device with a display. The electronic device 100 provides a user interface (UI, not labeled) displayed on the display unit 10. A number of UI components 13 are arranged in the UI, the UI components 13 can be arranged in a single layer or in multiple layers.

In this embodiment, the storage unit 40 is a non-transitory computer-readable medium configured to store a number of documents and multimedia files, such as video files, music files, and images. The storage unit 40 further stores a number of application programs and UI components 13 associated with the application programs. The UI components 13 include application icons and different kinds of interactive widgets. Each application icon and widget is associated with a corresponding application program. In one embodiment, the widget is a window for dynamically displaying images or information, such as weather information or time, or a thumbnail of a document, video, or image stored in the storage unit 40. In other embodiments, the widget is an interactive widget configured to provide feedback and display a processing result in response to a manual input. For example, the interactive widget is a currency converter, which includes an input box for inputting a currency and a currency value, and displays a converted result.

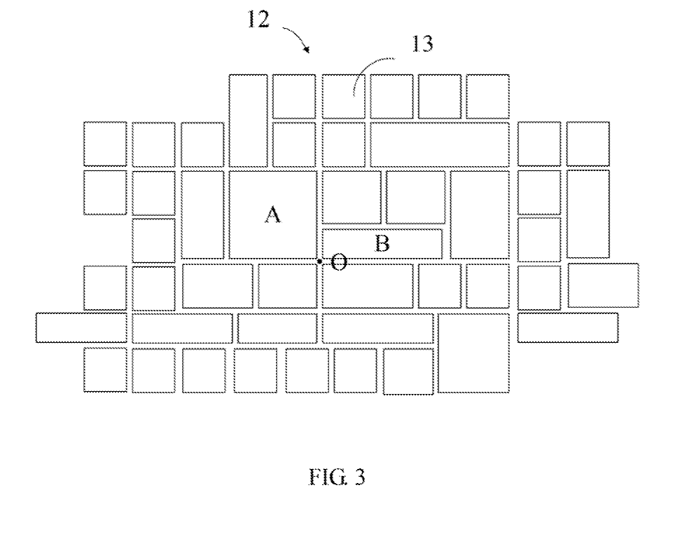

The display unit 10 is configured to simultaneously display videos, documents, Internet web pages, running interface of programs, a UI, and the like. The processing unit 20 is configured to run the application programs and control the display unit 10. The storage unit is further configured to store software instruments. The software instruments are run by the processing unit 20 for enabling the electronic device 100 to implement a dynamic map-type graphic interface 12 (shown in FIG. 3).

The input unit 30 can be selected from a contactless input device or a contact-type input device. The contactless input device can be a wireless control technology, such as gesture control technology or voice control technology. The contact-type input device can be a touch input device, such as a capacitive touch screen, a resistive touch screen, an Infrared touch screen, or other optical touch input devices, or other type of input device, such as a keyboard or a button.

The processing unit 20 includes a generating module 201, a UI controlling module 202, an application program managing module 204, an input controlling module 205 and a group controlling module 206.

FIG. 3 shows a first embodiment of a dynamic map-type graphic interface 12. The dynamic map-type graphic interface 12 is made up of the UI components 13 on a single layer. The UI components 13 are dynamically arranged according to a predetermined rule. Each of the UI components 13 is associated with one application program.

In this embodiment, the UI components 13 are arranged around a predetermined center O and spliced together to form the dynamic map-type graphic interface 12. A size of the dynamic map-type graphic interface 12 increases as the number of the UI components 13 increases. Each of the UI components 13 is a block of the map. A size, shape, and content of the block are determined by a character of the associated application program, or set by a user.

The size of the UI component 13 is measured by a predetermined unit of measurement.

In one embodiment, 1 unit is defined as 0.2 inches. For example, if the size of a UI component 13 is 1×4, the horizontal size of the UI component 13 is 0.2 inches, and the vertical size of the UI component 13 is 0.8 inches.

In another embodiment, the size of the UI component 13 is defined by pixel values. For example, if the size of the UI component 13 is 50×50, the horizontal size and the vertical size of the UI component 13 are both 50 pixels.

For example, a block A of the dynamic map-type graphic interface 12 is an application program for the weather and has a 3×3 size. Therefore, the horizontal size and the vertical size of the block A are both 0.6 inches. The content of the block A can include a static or dynamic image showing weather information of a city.

The UI components 13 are arranged around the predetermined center O according to the predetermined rule and spliced together. The UI components 13 are spliced together means that the UI components 13 are arranged around the center one by one according to the predetermined rule. The UI components 13 can be arranged closer to the center O according to a frequency of use, a time of installation, or other condition defined by a user. In other embodiments, arrangement of the UI components 13 on the dynamic map-type graphic interface 12 is random or determined by a user.

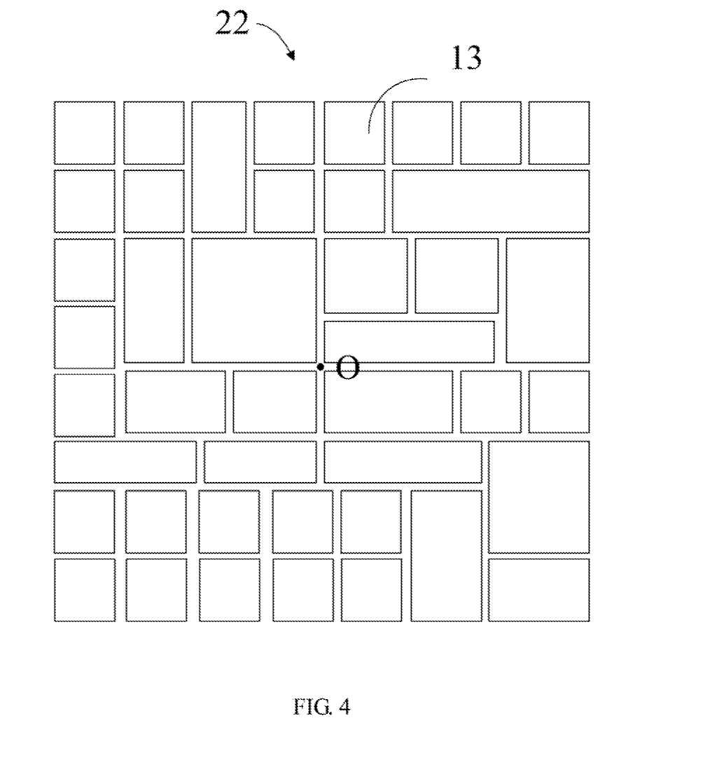

FIG. 4 shows another embodiment of a dynamic map-type graphic interface 22. A difference between the dynamic map-type graphic interface 22 and the dynamic map-type graphic interface 12 of the first embodiment is that the dynamic map-type graphic interface 22 is rectangular and has a fixed aspect ratio. As the number of the UI components 13 increases, the size of the rectangle increases to maintain the fixed aspect ratio of the dynamic map-type graphic interface 22.

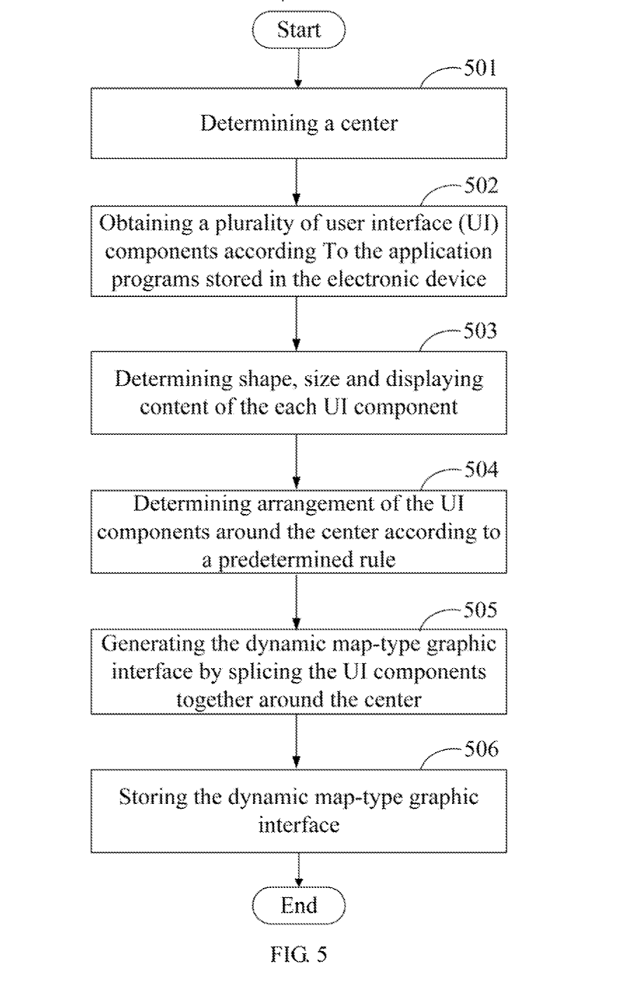

FIG. 5 shows a flowchart of a method for providing the dynamic map-type graphic interface 12. The method includes the following blocks, each of which is tied to various components contained in the electronic device 100 as shown in FIG. 2.

In block 501, the generating module 201 determines a center O.

In block 502, the application program managing module 204 obtains the number of the UI components 13 according to the application programs stored in the electronic device 100.

In block 503, the application program managing module 204 determines the shape, size, and content of each UI component 13 according to the character of the application program associated with each UI component 13, or according to user input.

In block 504, the generating module 201 determines the arrangement of the UI components 13 around the center O according to the first predetermined rule. In other embodiments, the arrangement of the UI components 13 is random or determined by a user.

In block 505, the generating module 201 generates the dynamic map-type graphic interface 12 by splicing the UI components 13 together around the center O.

In block 506, the dynamic map-type graphic interface 12 is stored in the storage unit 40 of the electronic device 100.

In other embodiments, the generating module 201 splices the UI components 13 together around the center O to form a dynamic picture.

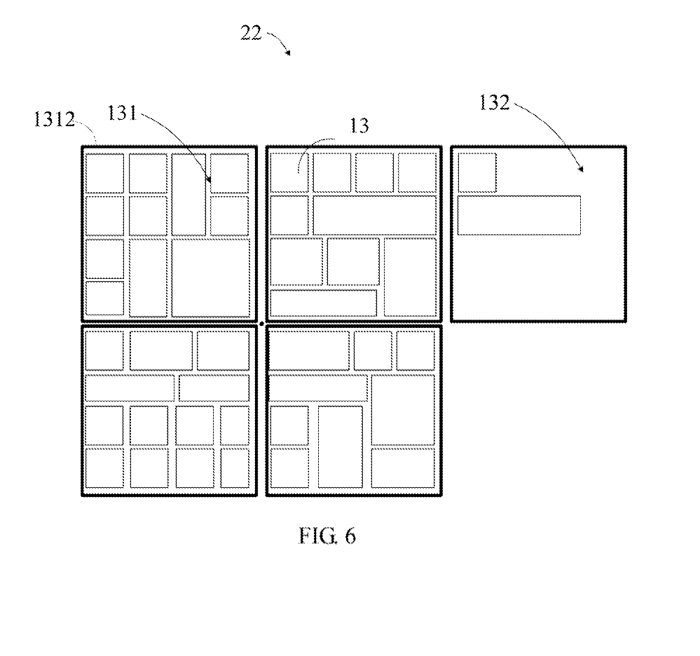

FIG. 6 shows a second embodiment of a dynamic map-type graphic interface 32. The dynamic map-type graphic interface 32 is also made up of the UI components 13 on a single page; each of the UI components 13 is associated with one application program. A difference between the dynamic map-type graphic interface 32 and the dynamic map-type graphic interface 12 of the first embodiment is that the dynamic map-type graphic interface 32 includes a number of first groups 131. The UI components 13 of the dynamic map-type graphic interface 32 are grouped into the number of first groups 131, each of the first groups 131 includes at least one UI component 13. The first groups 131 are dynamically arranged according to a predetermined rule and spliced together to form the dynamic map-type graphic interface 32.

Similar to the first embodiment, the application program managing module 204 determines the shape, size, and content of each UI component 13 of the dynamic map-type graphic interface 32 according to the character of the application program associated with each UI component 13, or according to user input. The character of the associated application program includes size parameter, shape parameter, content parameter, arrangement parameter and group parameter of the corresponding UI components 13. The group parameter of the character of the application program includes a group name configured to define which group 131 the corresponding UI components 13 belong to. The group parameter can be set by the associated application program or set by manual input.

The group controlling module 206 is configured to obtain the group parameter of the each UI components 13 of the associated application program, and group the UI components 13 into the corresponding first group 131 according the group parameters. In detail, the group controlling module 206 obtains the group name of group parameter of the each UI component 13 of the associated application program, and gathers the UI components 13 which have the same group parameter into the corresponding first group 131.

In the second embodiment, the dynamic map-type graphic interface 32 further includes a second group 132. When the group controlling module 206 determines that the group parameter of the new application program is empty, the group controlling module 206 groups the associated UI component 13 into the second group 132. The group controlling module 206 further groups the UI component 13 into a first group 131 according to manual input.

The UI component 13 associated with a new application programs are grouped into the second group 132. The new application program is an application program installed on the electronic device 100 in a recent predetermined time period or an application program installed on the electronic device 100 that has never been used. In an embodiment, when the new application program is used for the first time, the group controlling module 206 obtains the group parameter of the new application program, and groups the associated UI component 13 into the corresponding first group 131 according to the group parameter.

In the second embodiment, the dynamic map-type graphic interface 32 further includes frames 1312 circumscribing around the first group 131 and the second group 132.

The generating module 201 is configured to determine the arrangement of the first group 131 and the second group 132 around the center O according to a second predetermined rule, and generate the dynamic map-type graphic interface 32 by splicing the first group 131 and the second group 132 together around the center O. The first group 131 and the second group 132 are spliced together means the first groups 131 and the second group 132 are arranged around the center O one by one according to the second predetermined rule. In an embodiment, the first group 131 and the second group 132 can be arranged closer to the center O according to a frequency of use, a time of installation, or other conditions defined by a user. In other embodiments, arrangement of the first group 131 and the second group 132 on the dynamic map-type graphic interface 32 is random or determined by a user.

In one embodiment, the generating module 201 further determines the arrangement of the UI components 13 relative to the center O in the first group 131 and the second group 132 according to a third predetermined rule, when the arrangement of the first group 131 and the second group 132 has been determined. For example, the UI components 13 can be arranged closer to the center O according to a frequency of use.

In another embodiment, the generating module 201 further determines the arrangement of the UI components 13 in the first group 131 and the second group 132 according to a fourth predetermined rule, when the arrangement of the first group 131 and the second group 132 has been determined. For example, the UI components 13 can be orderly arranged in row array or column array according to a frequency of use, a time of installation, or other conditions defined by a user.

In other embodiments, arrangement of the UI components 13 in the first group 131 and the second group 132 is random or determined by a user.

The first group 131 and the second group 132 of the dynamic map-type graphic interface 32 is a block made up of the corresponding UI components 13 spliced together. In an embodiment, the first group 131 and the second group 132 are rectangular and have a fixed aspect ratio, the UI components 13 can be spliced via an original size or a compressed size.

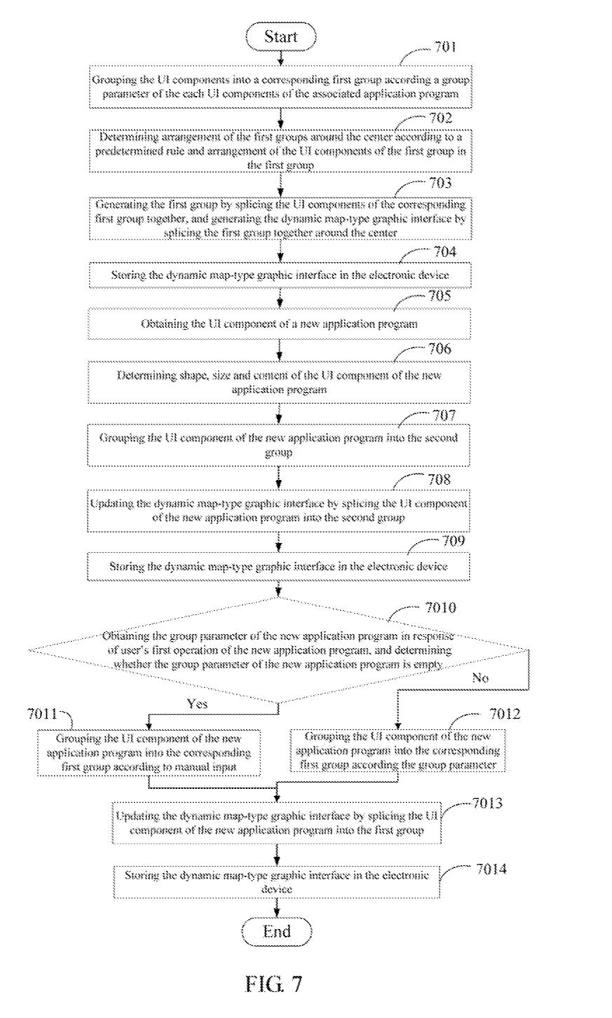

FIG. 7 illustrates a flowchart of a group control method for controlling the dynamic map-type graphic interface 32, the group control method includes the following blocks:

In block 701, the group controlling module 206 groups the UI components 13 into the corresponding first group 131 according the group parameters of the each UI component 13 of the associated application program. In detail, the group controlling module 206 obtains the group parameter of the each UI component 13 of the associated application program, and groups the UI components 13 into the corresponding first group 131 according to the group parameters. In an embodiment, the block 701 further includes: the group controlling module 206 grouping the UI components 13 into the second group 132, when the group controlling module 206 determines that the group parameter of the UI component 13 of the associated application program is empty.

In block 702, the generating module 201 determines the arrangement of the first group 131 around the center O according to the second predetermined rule and the arrangement of the UI components 13 of the first group 131 in the first group 131. In an embodiment, the block 702 further includes: the generating module 201 determining the arrangement of the second group 132 around the center O according to the second predetermined rule, and determines the arrangement of the UI components 13 of the second group 132 in the second group 132.

In block 703, the generating module 201 generates the first group 131 by splicing the UI components 13 of the corresponding first group 131 together, and generates the dynamic map-type graphic interface 32 by splicing the first group 131 together around the center O. In detail, the generating module 201 generates the first groups 131 by splicing the UI components 13 of the corresponding first group 131 together according the determined arrangement of the UI components 13 in the first group 131. In an embodiment, the block 703 further includes: generating the second group 132 by splicing the UI components 13 of the second group 132 together, and generating the dynamic map-type graphic interface 32 by splicing the first group 131 and the second group 132 around the center O.

In block 704, storing the dynamic map-type graphic interface 32 in the storage unit 40 of the electronic device 100.

When a new application program is installed on the electronic device, the group control method includes the following blocks:

In block 705, the application program managing module 204 obtains the UI component 13 of the new application program. The new application program is an application program installed on the electronic device 100 in a recent predetermined time period or an application program installed on the electronic device 100 has never been used.

In block 706, the application program managing module 204 determines the shape, size, and content of the UI component 13 of the new application program according to the character of the new application program, or according to user input.

In block 707, the group controlling module 206 groups the UI component 13 of the new application program into the second group 132.

In block 708, the generating module 201 updates the dynamic map-type graphic interface 32 by splicing the UI component 13 of the new application program into the second group 132. In detail, the generating module 201 determines the arrangement of the UI components 13 of the new application program in the second group 132 and updates the dynamic map-type graphic interface 32 by splicing UI component 13 of the new application program into the second group 132.

In block 709, the updated dynamic map-type graphic interface is stored in the storage unit 40.

When user operates the new application program for the first time, the group control method includes the following blocks:

In block 7010, the group controlling module 206 obtains the group parameter of the new application program in response to a first operation of the new application program, and determines whether the group parameter of the new application program is empty, if yes, goes to block 7011; if no, goes to block 7012.

In block 7011, the group controlling module 206 groups the UI component 13 of the new application program into the corresponding first group 131 according to manual input.

In block 7012, the group controlling module 206 groups the UI component 13 of the new application program into the corresponding first group 131 according the group parameter.

In block 7013, the generating module 201 updates the dynamic map-type graphic interface 32 by splicing the UI component 13 of the new application program into the corresponding first group 131.

In block 7014, the updated dynamic map-type graphic interface is stored in the storage unit 40.

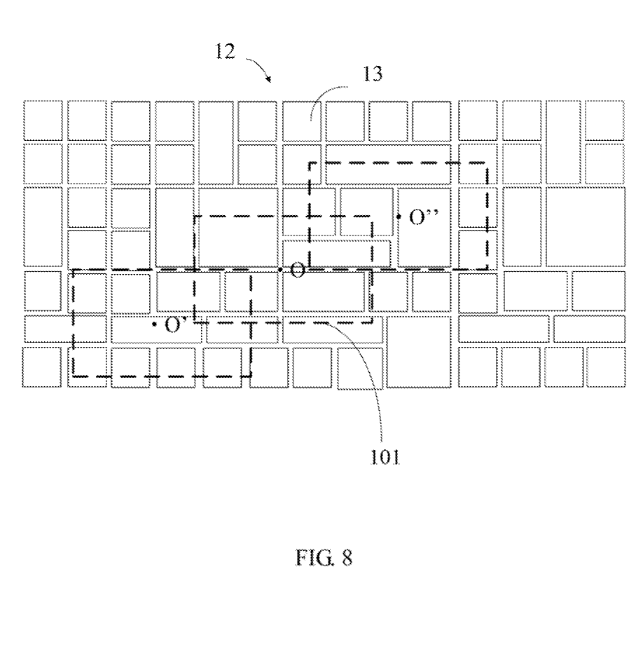

FIG. 8 illustrates when the size of the dynamic map-type graphic interface 12 is larger than a display size of the display unit 10, the UI controlling module 202 of the processing unit 20 determines a point of the dynamic map-type graphic interface 12 as a display center, then controls the display unit 10 to display a partial region 101 of the dynamic map-type graphic interface 12 centered around the display center. In this embodiment, a size of the partial region 101 is the size of the display unit 10.

In this embodiment, the center O is determined as the display center. In other embodiments, any point of the map-type graphic interface 12, such as a point O′ or a point O″, can be defined as the current display center. The current display center can be the most recent display center or be set by a user.

The input unit 30 is configured to receive a manual input and generate an input command in response to the input. The input controlling module 205 of the processing unit 20 generates corresponding control signals according to the different input commands. The UI controlling module 202 controls the display center of the dynamic map-type graphic interface 12 to move according to the control signal when the input command is the movement command.

For example, FIG. 8, illustrates the UI controlling module 202 controls the display center of the dynamic map-type graphic interface 12 to move from the center O to the point O′ or O″, then the partial region 101 is moved accordingly to around the point O′ or the point O″.

For example, if the input unit 30 is a touch panel, when the touch panel is swiped, the input unit 30 generates the corresponding input command. The input controlling module 205 determines a distance and a direction of the swipe, and generates the control signal according to the movement command. The control signal includes information of the distance and the direction of the swipe. The UI controlling module 202 determines a movement distance and a movement direction according to the control signal, and controls the display center of the dynamic map-type graphic interface 12 to move according to the determined movement direction and the determined movement distance.

In one embodiment, the movement direction is the same as the swiping direction, and the movement distance is proportional to the swiping distance. For example, when the swiping distance is 0.5 cm, the determined movement distance is 1 unit.

In another embodiment, the movement direction is opposite to the swiping direction.

In other embodiments, the input controlling module 205 determines the direction of the swipe and the speed of the swipe. The UI controlling module 202 determines the movement direction according to the direction of the swipe, and determines the movement distance according to the speed of the swipe. For example, the movement distance can be determined larger according with a faster swipe speed.

When the display center is adjacent to a boundary of the dynamic map-type graphic interface 12, the UI controlling module 202 redefines the display center, such that the partial region 101 is within the dynamic map-type graphic interface 12.

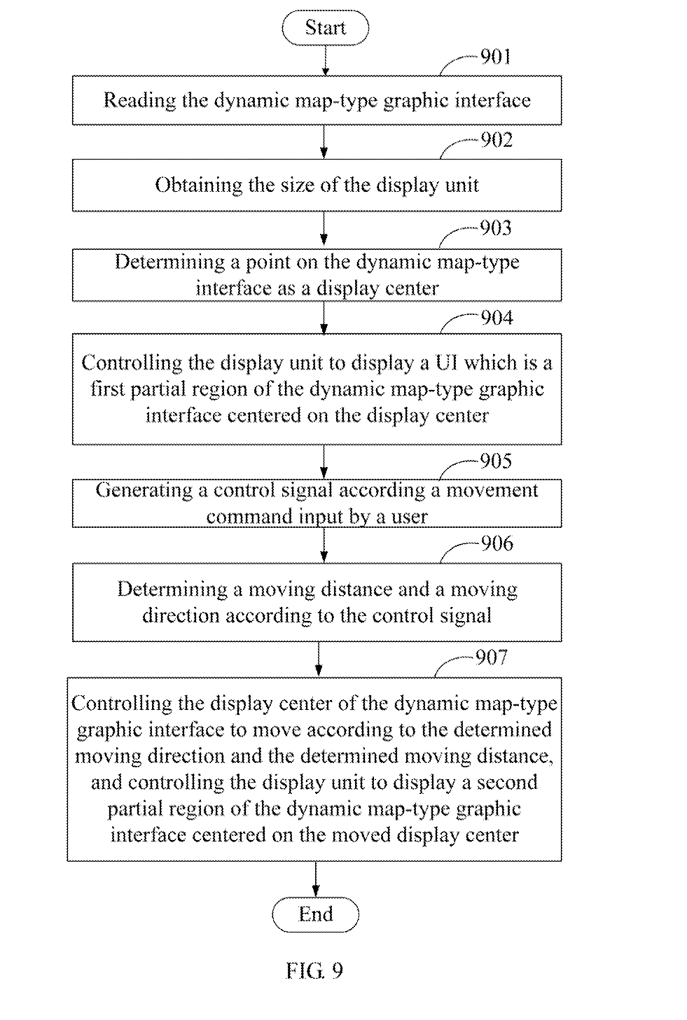

FIG. 9 illustrates a flowchart of a method for controlling the partial region 101 displayed on the electronic device 100. The method includes the following blocks,

In block 901, the UI controlling module 202 reads the dynamic map-type graphic interface 12 from the storage unit 40.

In block 902, the UI controlling module 202 obtains the size of the display unit 10. In one embodiment, the UI controlling module 202 further determines whether the size of the display unit 10 is larger than the size of the dynamic map-type graphic interface 12. If the size of the display unit 10 is larger than the size of the dynamic map-type graphic interface 12, block 703 is implemented. Otherwise, the UI controlling module 202 controls the display unit 10 to display the content of dynamic map-type graphic interface 12.

In block 903, the UI controlling module 202 determines a point on the dynamic map-type interface as a display center. In this embodiment, the UI controlling module 202 determines the center O of the dynamic map-type graphic interface 12 as the display center. In other embodiments, any point selected by a user or the most recent display center can be defined as the current display center.

In block 904, the UI controlling module 202 controls the display unit 10 to display the partial region 101 of the dynamic map-type graphic interface 12 around the display center.

In block 905, the input controlling module 205 generates a control signal according to a movement command input by a user.

In block 906, the UI controlling module 202 determines a movement distance and a movement direction according to the control signal.

In block 907, the UI controlling module 202 controls the display center of the dynamic map-type graphic interface 12 to move according to the determined movement direction and the determined movement distance, and controls the display unit 10 to display the partial region 101 around the moved display center.

The dynamic map-type graphic interface 12 is a single-layer graphic interface made up of the UI components 13 spliced together. The UI components 13 are dynamically arranged around the center O. Furthermore, the dynamic map-type graphic interface 12 is compatible with different electronic devices having different display sizes.

The embodiments shown and described above are only examples. Many details are often found in the art such as the other features of a protection case. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A group control method for controlling a map-type graphical user interface with a plurality of graphical representative user interface (UI) components comprising:
grouping, at an electronic device, a available UI component into a corresponding first group according a group parameter;
determining, at the electronic device, an arrangement of the first group around a center of the map-type graphical user interface according to a predetermined rule;
updating, at the electronic device, the map-type graphical user interface by splicing the UI components of the corresponding first group around the center, based on the predetermined rule; and
storing, at the electronic device, the updated dynamic map-type graphic user interface.

2. The method of claim 1, further comprising:
grouping the UI component into a second group at the electronic device, when the group parameter of the UI component is empty;
determining, at the electronic device, an arrangement of the second group around the center according to the predetermined rule;
updating, at the electronic device, the map-type graphical user interface by splicing the UI components of the corresponding second group around the center, based on the predetermined rule; and
storing, at the electronic device, the updated dynamic map-type graphic user interface.

3. The method of claim 2, further comprising:
receiving, at the electronic device, a new notification of a UI component;
determining, at the electronic device, a shape, a size and a content of the UI component;
adding, at the electronic device, the UI component into the second group;
updating, at the electronic device, the dynamic map-type graphic interface by splicing the UI component into the second group; and
storing, at the electronic device, the updated dynamic map-type graphic interface.

4. The method of claim 3, further comprising:
receiving, at the electronic device, a new application program group parameter; and determining, at the electronic device, whether the group parameter of the new application program is empty;
adding, at the electronic device, the UI component of the new application program into the second group, manually, when the group parameter of the new application program is empty;
grouping, at the electronic device, the UI component of the new application program into the corresponding first group, according the group parameter;
updating, at the electronic device, the dynamic map-type graphic interface, by splicing the UI component of the new application program into the corresponding group; and
storing, at the electronic device, the dynamic map-type graphic interface in the electronic device.

5. The method of claim 1, wherein the group parameter comprises a group name.

6. The method of claim 1, wherein the new application program is an application program installed on the electronic device in a recent predetermined time period or an application program installed on the electronic device had never been used.

7. The method of claim 1, wherein the dynamic map-type graphic interface further includes frames circumscribing around the first groups.

8. An electronic device, comprising:
a display unit;
a processing unit; and
a storage unit configured to store a plurality of application programs and user interface (UI) components associated with the application programs, and a dynamic map-type graphic interface comprising a plurality of first groups around a center, each of the first group comprising at least one UI component spliced together;
wherein the storage unit is further configured to store a plurality of instructions, which when executed by the processing unit, causes the processing unit to:
grouping, at an electronic device, a UI component into a corresponding first group according a group parameter;
determining, at the electronic device, an arrangement of the first group around a center of the map-type graphical user interface according to a predetermined rule;
updating, at the electronic device, the map-type graphical user interface by splicing the UI components of the corresponding first group around the center, based on the predetermined rule; and
storing, at the electronic device, the updated dynamic map-type graphic user interface.

9. The electronic device of claim 8, wherein when the instructions executed by the processing unit, further causes the processing unit to:
grouping the UI component into a second group at the electronic device, when the group parameter of the UI component is empty;
determining, at the electronic device, an arrangement of the second group around the center according to the predetermined rule;
updating, at the electronic device, the map-type graphical user interface by splicing the UI components of the corresponding second group around the center, based on the predetermined rule; and
storing, at the electronic device, the updated dynamic map-type graphic user interface.

10. The electronic device of claim 9, wherein when the instructions executed by the processing unit, further causes the processing unit to:
receiving, at the electronic device, a new notification of a UI component;
determining, at the electronic device, a shape, a size and a content of the UI component;
adding, at the electronic device, the UI component into the second group;
updating, at the electronic device, the dynamic map-type graphic interface by splicing the UI component into the second group; and
storing, at the electronic device, the updated dynamic map-type graphic interface.

11. The electronic device of claim 10, wherein when the instructions executed by the processing unit, further causes the processing unit to:
receiving, at the electronic device, a new application program group parameter;
determining, at the electronic device, whether the group parameter of the new application program is empty;
adding, at the electronic device, the UI component of the new application program into the second group, manually, when the group parameter of the new application program is empty;
grouping, at the electronic device, the UI component of the new application program into the corresponding first group, according the group parameter;
updating, at the electronic device, the dynamic map-type graphic interface, by splicing the UI component of the new application program into the corresponding group; and
storing, at the electronic device, the dynamic map-type graphic interface in the electronic device.

12. The electronic device of claim 8, wherein the group parameter comprises a group name.

13. The electronic device of claim 8, wherein the new application program is an application program installed on the electronic device in a recent predetermined time period or an application program installed on the electronic device had never been used.

14. The electronic device of claim 8, wherein the dynamic map-type graphic interface further includes frames circumscribing around the first groups.

15. A group control system for controlling a dynamic map-type graphic interface of an electronic device, the dynamic map-type graphic interface comprising a plurality of graphical representative user interface (UI) components, each of the UI components associated to an application program of the electronic device; the updating system comprising:
a group controlling module configured to group the UI component into a corresponding first group according a group parameter of the UI component; and
a generating module configured to determine arrangement of the first group around a center of the map-type graphical user interface according to a predetermined rule, update the map-type graphical user interface by splicing the UI components of the corresponding first group around the center, based on the predetermined rule; and store the updated dynamic map-type graphic interface in the electronic device.

16. The group control system of claim 15, wherein the group controlling module is further configured to group the UI component into a second group, when the group parameter of the UI component is empty; and determine arrangement of the second group around the center of the map-type graphical user interface according to the predetermined rule; and
the generating module is further configured to update the map-type graphical user interface by splicing the UI components of the corresponding second group around the center, based on the predetermined rule.

17. The group control system of claim 16, further comprising an application program managing module configured to receive a new notification of a UI component and determine a shape, size and content of the UI component;
wherein the group controlling module is further configured to group the UI component into the second group; and
the generating module is further configured to update the dynamic map-type graphic interface by splicing the UI component into the second group; and store the updated dynamic map-type graphic interface in the electronic device.

18. The group control system of claim 17, wherein the group controlling module is further configured to receive a new application program group parameter, determine whether the group parameter of the new application program is empty; add the UI component of the new application program into the second group, manually, when the group parameter of the new application program is empty; and group the UI component of the new application program into the corresponding first group, according the group parameter; and
the generating module is further configured to update the dynamic map-type graphic interface by splicing the UI component of the new application program into the corresponding group; and store the updated dynamic map-type graphic interface in the electronic device.

19. The group control system of claim 15, wherein the group parameter comprises a group name.

20. The group control system of claim 15, wherein the dynamic map-type graphic interface further includes frames circumscribing around the first groups.
